(19) United States
(12) Patent Application Publication
(10) Pub. No.: US 2026/0167219 A1
(43) Pub. Date: Jun. 18, 2026

(54) AGILE ADAPTIVE CONTROL

(71) Applicant: GM Global Technology Operations LLC, Detroit, MI (US)

(72) Inventors: Mohammadali Shahriari, Markham (CA); Ashraf Abualfellat, Grand Blanc, MI (US); Mohammed Raju Hossain, Markham (CA); Mehdi Abroshan, Waterloo (CA)

(73) Assignee: GM Global Technology Operations LLC, Detroit, MI (US)

(21) Appl. No.: 18/983,731

(22) Filed: Dec. 17, 2024

(51) Int. Cl. B60W 60/00; B60W 10/20; B60W 50/00

(52) U.S. Cl. CPC B60W 60/001; B60W 10/20; B60W 50/00; B60W 2050/0022; B60W 2050/0052; B60W 2540/18; B60W 2556/10

(57) ABSTRACT

A method using agile adaptive control (A2C) includes receiving, as input to an agile adaptive control model, planning data including a desired path of a vehicle, and receiving, as input to the agile adaptive control model, vehicle data of the vehicle. The method also includes determining, based on the planning data and the vehicle data, that a position error of the vehicle exceeds a position threshold, and initiating an agile learn model of the adaptive control model to update initial adaptive design parameters based on the planning data and the vehicle data. The method also includes generating updated adaptive design parameters and generating, using a control model of the adaptive control model, a control command based on the updated adaptive design parameters.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an agile adaptive control algorithm for vehicle controls. Generally, in the development of autonomous vehicles, control systems are crucial for ensuring safe and efficient navigation. Currently, these systems rely on a combination of sensor inputs, including cameras, light detection and ranging (LiDAR), radar, and global positioning systems (GPS), to generate real-time data about the vehicle's surroundings. This data is processed through complex algorithms to determine the optimal maneuvers needed to navigate various driving scenarios. The control algorithms typically involve multiple layers of vehicle parameter learning and adaptation, which allow the system to adjust to different driving conditions and maintain stability. However, methods that provide real-time responsiveness, particularly when the learning process is slower than the disturbance dynamics encountered during driving, are of particular interest.

For instance, the need for additional calibration is increasingly arising as vehicles rapidly evolve to include more autonomous features. However, any delay in calibration may result in suboptimal maneuver responses, especially in dynamic environments where quick adjustments are necessary. This limitation underscores the importance of developing more agile learning algorithms that can enhance the responsiveness and accuracy of controls by minimizing the parameters needed to learn, thereby improving the overall safety and performance of autonomous vehicles.

### SUMMARY

One aspect of the disclosure provides a computer-implemented method for cloud-based scalable positioning systems that when executed on data processing hardware causes the data processing hardware to perform operations that include receiving, as input to an agile adaptive control model, planning data including a desired path of a vehicle, and receiving, as input to the agile adaptive control model, vehicle data of the vehicle. The operations also include determining, based on the planning data and the vehicle data, that a position error of the vehicle exceeds a position threshold, initiating an agile learn model of the adaptive control model to update initial adaptive design parameters based on the planning data and the vehicle data. The operations further include generating updated adaptive design parameters, and generating, using a control model of the adaptive control model, a control command based on the updated adaptive design parameters.

Implementations of the disclosure may include one or more of the following optional features. In some implementations, generating the updated adaptive design parameters includes calculating a first gain of the initial adaptive design parameters and a second gain of the initial adaptive design parameters. In these implementations, generating the updated adaptive design parameters may further include applying an adaptive filter to the initial adaptive design parameters. Here, the adaptive filter may apply one or more preset vehicle parameters to the first gain of the initial adaptive design parameters and the second gain of the initial adaptive design parameters.

In some examples, the planning data further includes a blend path of the vehicle. In these examples, the blend path may include a lateral transition between a current trajectory of the vehicle and the desired path of the vehicle. In some implementations, the position error indicates a difference between the desired path of the vehicle and a current trajectory of the vehicle. In some examples, the vehicle data includes one or more of a measured steering angle, a previous control command, and the initial adaptive design parameters. In some implementations, the agile adaptive control model is configured to, for each maneuver of the vehicle, generate updated parameters without additional calibration of the vehicle. In some examples, the control command is transmitted to a steering control of the vehicle.

Another aspect of the disclosure provides a system for cloud-based scalable positioning that includes data processing hardware and memory hardware in communication with the data processing hardware. The memory hardware stores instructions that when executed by the data processing hardware cause the data processing hardware to perform operations that include receiving, as input to an agile adaptive control model, planning data including a desired path of a vehicle, and receiving, as input to the agile adaptive control model, vehicle data of the vehicle. The operations also include determining, based on the planning data and the vehicle data, that a position error of the vehicle exceeds a position threshold and initiating an agile learn model of the adaptive control model to update initial adaptive design parameters based on the planning data and the vehicle data. The operations further include generating updated adaptive design parameters, and generating, using a control model of the adaptive control model, a control command based on the updated adaptive design parameters.

This aspect may include one or more of the following optional features. In some implementations, generating the updated adaptive design parameters includes calculating a first gain of the initial adaptive design parameters and a second gain of the initial adaptive design parameters. In these implementations, generating the updated adaptive design parameters may further include applying an adaptive filter to the initial adaptive design parameters. Here, the adaptive filter may apply one or more preset vehicle parameters to the first gain of the initial adaptive design parameters and the second gain of the initial adaptive design parameters.

In some examples, the planning data further includes a blend path of the vehicle. In some examples, the vehicle data includes one or more of a measured steering angle, a previous control command, and the initial adaptive design parameters. In some implementations, the agile adaptive control model is configured to, for each maneuver of the vehicle, generate updated parameters without additional calibration of the vehicle.

Another aspect of the disclosure provides a method for latency masking that when executed on data processing hardware causes the data processing hardware to perform operations that include receiving, as input to an agile adaptive control model, planning data of a vehicle, receiving, as input to the agile adaptive control model, vehicle data of the vehicle, and initiating an agile learn model of the adaptive control model to update initial adaptive design parameters based on the planning data and the vehicle data. The operations also include generating updated adaptive design parameters, and generating, using a control model of the adaptive control model, a control command based on the updated adaptive design parameters. This aspect may include one or more of the following optional features. In some implementations, generating the updated adaptive design parameters includes calculating a first gain of the initial adaptive design parameters and a second gain of the initial adaptive design parameters, and applying an adaptive filter to the initial adaptive design parameters. In these implementations, the adaptive filter may apply one or more preset vehicle parameters to the first gain of the initial adaptive design parameters and the second gain of the initial adaptive design parameters.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for agile adaptive control (A2C).

FIG. 2 is a schematic view of example components of the system of FIG. 1.

FIG. 3 is an example of a vehicle control adjustment using the system of FIG. 1.

FIG. 4 are examples of vehicle maneuvers using the system of FIG. 1.

FIG. 5 is flowchart of an example arrangement of operations for a method for A2C.

FIG. 6 is flowchart of an example arrangement of operations for a method for A2C.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

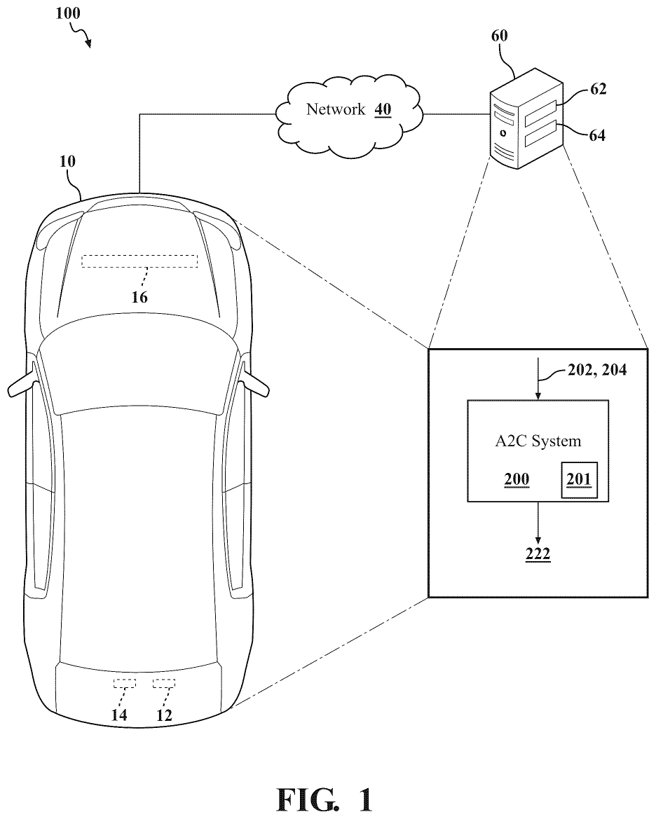

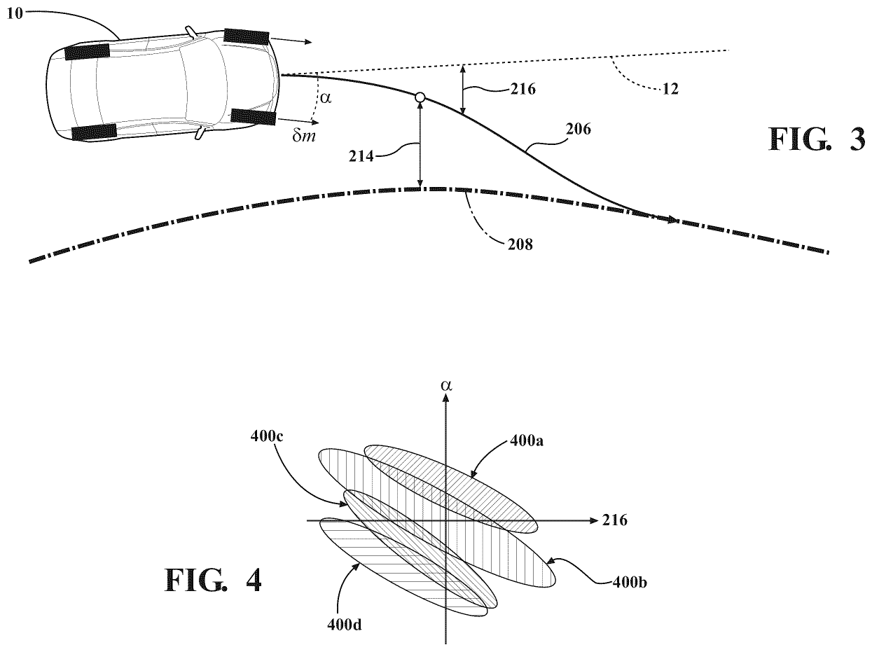

Referring to FIG. 1, in some implementations, a system 100 includes a vehicle 10 and/or a remote system 60 in communication with the vehicle 10 via a network 40 (e.g., wired or wireless communication). The vehicle 10 and/or the remote system 60 execute an agile adaptive control (A2C) system 200 configured to apply a simplified mathematical model that implements an agile learning algorithm to improve vehicle controls when performing maneuvers 400 (FIG. 4) of the vehicle 10 without the need to perform extra calibration of the vehicle 10. As described in greater detail below, rather than relying on multiple different layers of vehicle parameters that are learned and adapted to maintain vehicle control fidelity, the A2C system 200 implements an A2C model 201 that effectively learns the error of the vehicle 10 using minimal adaptive design parameters 212 such that the A2C model 201 mathematically stabilizes the A2C system 200 with minimized gain scheduling needs. Notably, the A2C model 201 may capture all model and environmental uncertainties associated with the vehicle 10 in an effectively linear fashion. As used herein, the vehicle controls may generally refer to a lateral control of the vehicle 10, a longitudinal control of the vehicle 10, or any other controlling aspects that dictate the maneuvers 400 of the vehicle 10. Maneuvers 400 may refer to any movement pattern (e.g., changing lanes, parallel parking, following a curved path, braking, etc.) of the vehicle 10.

In the examples shown, the A2C system 200 is implemented within a vehicle 10. However, the A2C system 200 can be implemented on other computing devices (e.g., computing devices in communication with the vehicle 10), such as, without limitation, a smart phone, tablet, smart display, desktop/laptop, smart watch, smart appliance, or smart glasses/headset. Additionally or alternatively, the A2C system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 14 to perform operations. The vehicle 10 further includes one or more sensors 16 configured to capture/receive sensor data of the vehicle 10. In some implementations, one or more sensors 16 may include one or more long range radar sensors and/or one or more camera sensors capable of capturing image data. Additionally or alternatively, the sensor data may include vehicle data 202 of the vehicle 10.

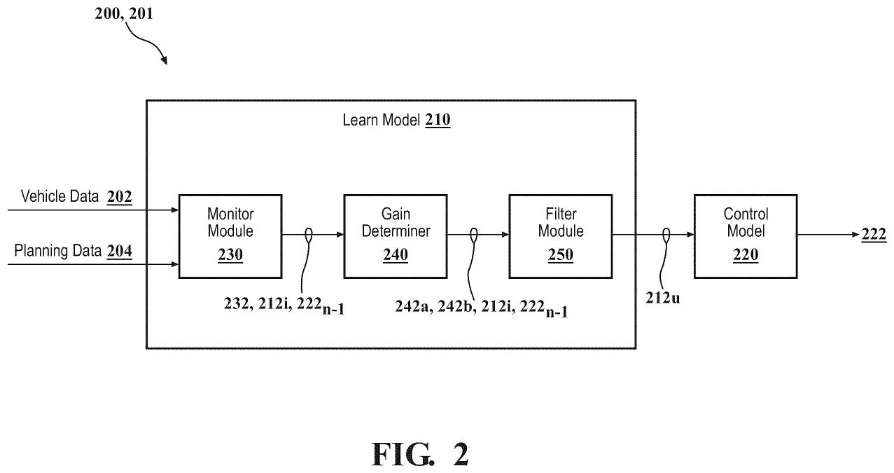

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the A2C system 200 is shared across the cluster 20 of the vehicles 10 and the remote system 60. As shown in FIGS. 1 and 2, the A2C system 200 executing the A2C model 201 includes a learn model 210 and a control model 220 that cooperate to continuously evaluate measured vehicle data 202 and planning data 204 and generate control commands 222 for downstream systems (e.g., steering, braking, etc.) of the vehicle 10 to implement during maneuvers 400. The learn model 310 may include a monitor module 230, a gain determiner 240, and a filter module 250 that cooperate with the control model 220 to generate the updated adaptive design parameters 212u for the vehicle 10 used to determine the control command 222 while the vehicle 10 is performing maneuvers 400.

With particular reference to FIGS. 1 and 3, while the vehicle 10 is moving, the A2C system 200 continuously receives vehicle data 202 and planning data 204 characterizing a current maneuver 400 of the vehicle 10. The vehicle data 202 may generally refer to the measured steering angle α of the vehicle 10 with respect to a current trajectory 12 of the vehicle 10, the previously generated control command 222ₙ₋₁, and the initial (i.e., most recently calculated) adaptive design parameters 212i of the vehicle 10, where n refers to the current time-step of the system 100. Notably, the control command 222 may include a vector including the adaptive design parameters 212i of the vehicle 10. The planning data 204 may generally include a desired path 208 of the vehicle 10 and a desired blend path 206 of the vehicle 10. As shown in FIG. 3, the desired path 206 may be the path needed for the vehicle 10 to correct its course from its current trajectory 12 to the desired path 208 on which the vehicle 10 should be traveling. As used herein, at any given time step, the lateral difference between the desired path 208 and the desired blend path 206 may be referred to as the position error 214 of the vehicle 10, while the lateral difference between the current trajectory 12 of the vehicle 10 and the desired blend path 206 may referred to the position offset 216.

Referring again to FIG. 2, the monitor module 230 of learn model 210 receives the vehicle data 202 and the planning data 204 as input. Here, the monitor module 230 may include a configurable position threshold for the vehicle 10. The position threshold may generally refer to the threshold at which the fidelity of the control of the vehicle 10 for a particular maneuver 400 is acceptable. For instance, if the vehicle data 202 including the position error 214 of the vehicle 10 indicates that the position error 214 exceeds the position threshold, the monitor module 230 may generate a trigger 232 to the gain determiner 240 to update the initial adaptive design parameters 212i currently being implemented.

In the instances where the vehicle data 202 and the planning data 204 indicates that the position error 214 does not exceed the position error, the learn model 210 may not update the initial adaptive design parameters 212i and continue to use the previously calculated command control 222n-1 in the maneuver 400 of the vehicle 10. Conversely, when the vehicle data 202 and the planning data 204 indicate that the position error 214 exceeds the position threshold, the learn model 210 may generate the trigger 232 for the gain determiner 240 to calculate one or more gains 242 of the vehicle 10. Here, the gain determiner 240 may calculate a first gain 242a of the initial adaptive design parameters 212i and a second gain 242b of the initial adaptive design parameters 212i for the current vehicle data 202 and the planning data 204 of the vehicle 10. The first gain 242a and the second gain 242b may be calculated, as follows:

$$242 a = 22 {2}_{n - 1} - {k}_{p , 1} \cdot {y}_{b} , \qquad ( 1 )$$

$$242 b = \frac{( 22 {2}_{n - 1} - {k}_{p , 0} )}{{y}_{b}} , \qquad ( 2 )$$

where k_{p,0} denotes the initial adaptive design parameter 212i for the previous time-step, k_{p,1} denotes the initial adaptive design parameter 212i for the instant time-step, and y_{b} denotes the position offset 216 of the vehicle 10.

The filter module 250 may receive the first gain 242a, the second gain 242b, the initial adaptive design parameters 212i, and the previous time-step command control 222ₙ₋₁ as input and apply an adaptive filter to the initial design parameters 212i to generate updated adaptive design parameters 212u. Here, the adaptive filter may include one or more preset vehicle parameters that are applied to the first gain 242a of the initial adaptive design parameters 212i and the second gain 242b of the initial adaptive design parameters 212i.

Referring briefly to FIG. 4, one or more maneuvers 400a-400d are shown. Each of the maneuvers 400 may be plotted on a graph where the x-axis represents the position offset 216, and the y-axis represents the measured steering angle α of the vehicle 10. As shown, this results in the maneuvers 400a-400d being plotted as respective ellipses. In its execution, the filter module 250 may apply the adaptive filter to the initial adaptive design parameters 212i by finding the offset and slope of each ellipse to generate an aligned fitting. In other words, the filter module 250 may apply the adaptive filter to the first gain 242a of the initial adaptive design parameters 212i and the second gain 242b of the initial adaptive design parameters 212i. Referring again to FIG. 3, the adaptive filter may be calculated, as follows:

$$212 {u}_{1} = 212 {i}_{1} ( {δ}_{1} ) + ( 1 - {δ}_{1} ) {ℊ}_{1} ( \frac{22 {2}_{n - 1} - 212 {i}_{0}}{{y}_{b}} ) , \qquad ( 3 )$$

$$212 {u}_{0} = 212 {i}_{0} ( {δ}_{0} ) + ( 1 - {δ}_{0} ) {ℊ}_{0} ( 22 {2}_{n - 1} - 212 {i}_{1} \cdot {y}_{b} ) , \qquad ( 4 )$$

where 212u₁ and 212u₀ denote the updated adaptive design parameters 212u, 212i₁ and 212i₀ denotes the initial adaptive design parameter 212i, δ denotes the learn gain, g represents the filter gain, and y_{b} denotes the position offset 216 of the vehicle 10. Here, the learn gain δ and the filter gain g may be preset parameters of the vehicle 10.

The filter module 250 of the learn model 210 may generate the updated adaptive design parameters 212u as output, which are then received, as input, by the control model 220. Here, the control model 220 may calculate the updated control command 222 based on the updated adaptive design parameters 212u. For instance, the control model 220 may calculate the updated control command 222, as follows:

$$222 = 212 {u}_{1} \cdot {y}_{b} + 212 {u}_{0} . \qquad ( 5 )$$

Notably, as the vehicle 10 performs its maneuver 400, the A2C model 201 generates the updated adaptive design parameters 212u and the corresponding updated control command 222 without additional calibration of the vehicle 10. Here, the updated control command 222 and/or the updated adaptive design parameters 212u may be provided to downstream navigation applications, such as steering control, or braking, in the vehicle 10 as feedback.

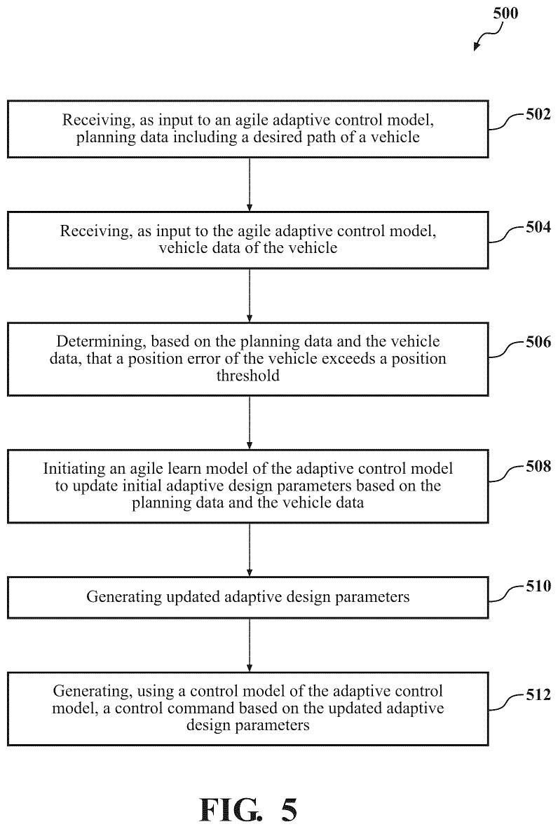

FIG. 5 includes a flowchart of an example arrangement of operations for a method 500 for agile adaptive control of a vehicle 10. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

At operation 502, the method 500 includes receiving, as input to an agile adaptive control model 202, planning data 204 including a desired blend path 206 of a vehicle 10. The method 500 also includes, at operation 504, receiving, as input to the agile adaptive control model 202, vehicle data 202 of the vehicle 10. The method 500 further includes, at operation 506, determining, based on the planning data 204 and the vehicle data 202, that a position error of the vehicle 10 exceeds a position threshold.

At operation 508, the method 500 also includes initiating an agile learn model 210 of the adaptive control model 202 to update initial adaptive design parameters 212i based on the planning data 204 of the vehicle 10 and the vehicle data 202. At operation 510, the method 500 further includes generating updated adaptive design parameters 212u. The method 500 also includes, at operation 512, generating, using a control model 220 of the adaptive control model 202, a control command 222 based on the updated adaptive design parameters 212u.

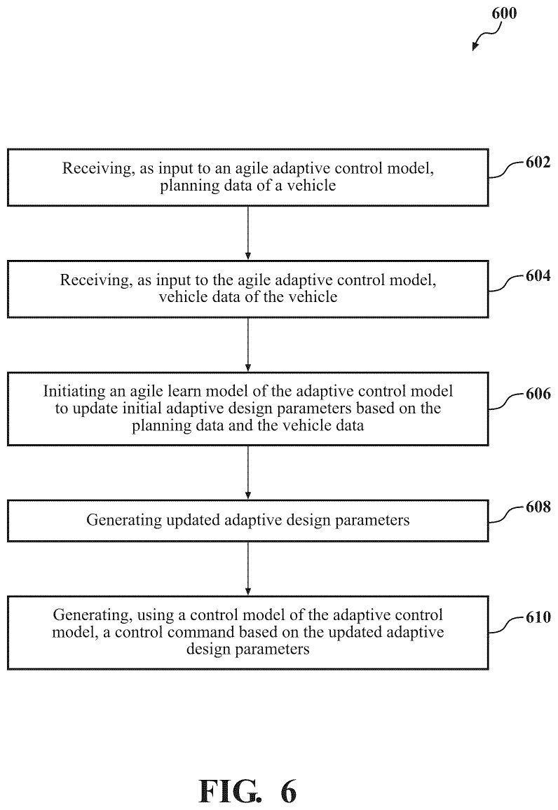

FIG. 6 includes a flowchart of an example arrangement of operations for a method 600 for agile adaptive control of a vehicle 10. The method 600 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 600.

At operation 602, the method 600 includes receiving, as input to an agile adaptive control model 202, planning data 204 of a vehicle 10. The method 600 also includes, at operation 604, receiving, as input to the agile adaptive control model 202, vehicle data 202 of the vehicle 10. At operation 606, the method 600 also includes initiating an agile learn model 210 of the adaptive control model 202 to update initial adaptive design parameters 212i based on the planning data 204 of the vehicle 10 and the vehicle data 202. At operation 608, the method 600 further includes generating updated adaptive design parameters 212u. The method 600 also includes, at operation 610, generating, using a control model 220 of the adaptive control model 202, a control command 222 based on the updated adaptive design parameters 212u.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving, as input to an agile adaptive control model, planning data including a desired path of a vehicle;
receiving, as input to the agile adaptive control model, vehicle data of the vehicle;
determining, based on the planning data and the vehicle data, that a position error of the vehicle exceeds a position threshold;
initiating an agile learn model of the adaptive control model to update initial adaptive design parameters based on the planning data and the vehicle data;
generating updated adaptive design parameters; and
generating, using a control model of the adaptive control model, a control command based on the updated adaptive design parameters.

2. The method of claim 1, wherein generating the updated adaptive design parameters comprises calculating a first gain of the initial adaptive design parameters and a second gain of the initial adaptive design parameters.

3. The method of claim 2, wherein the generating the updated adaptive design parameters further comprises applying an adaptive filter to the initial adaptive design parameters.

4. The method of claim 3, wherein the adaptive filter applies one or more preset vehicle parameters to the first gain of the initial adaptive design parameters and the second gain of the initial adaptive design parameters.

5. The method of claim 1, wherein the planning data further includes a blend path of the vehicle.

6. The method of claim 5, wherein the blend path includes a lateral transition between a current trajectory of the vehicle and the desired path of the vehicle.

7. The method of claim 1, wherein the position error indicates a difference between the desired path of the vehicle and a current trajectory of the vehicle.

8. The method of claim 1, wherein the vehicle data includes one or more of:
a measured steering angle;
a previous control command; and
the initial adaptive design parameters.

9. The method of claim 1, wherein the agile adaptive control model is configured to, for each maneuver of the vehicle, generate updated parameters without additional calibration of the vehicle.

10. The method of claim 1, wherein the control command is transmitted to a steering control of the vehicle.

11. A system comprising:
data processing hardware; and
memory hardware in communication with the data processing hardware, the memory hardware storing instructions that when executed on the data processing hardware cause the data processing hardware to perform operations comprising:
receiving, as input to an agile adaptive control model, planning data including a desired path of a vehicle;
receiving, as input to the agile adaptive control model, vehicle data of the vehicle;
determining, based on the planning data and the vehicle data, that a position error of the vehicle exceeds a position threshold;
initiating an agile learn model of the adaptive control model to update initial adaptive design parameters based on the planning data and the vehicle data;
generating updated adaptive design parameters; and
generating, using a control model of the adaptive control model, a control command based on the updated adaptive design parameters.

12. The system of claim 11, wherein generating the updated adaptive design parameters comprises calculating a first gain of the initial adaptive design parameters and a second gain of the initial adaptive design parameters.

13. The system of claim 12, wherein the generating the updated adaptive design parameters further comprises applying an adaptive filter to the initial adaptive design parameters.

14. The system of claim 13, wherein the adaptive filter applies one or more preset vehicle parameters to the first gain of the initial adaptive design parameters and the second gain of the initial adaptive design parameters.

15. The system of claim 11, wherein the planning data further includes a blend path of the vehicle.

16. The system of claim 11, wherein the vehicle data includes one or more of:
a measured steering angle;
a previous control command; and
the initial adaptive design parameters.

17. The system of claim 11, wherein the agile adaptive control model is configured to, for each maneuver of the vehicle, generate updated parameters without additional calibration of the vehicle.

18. A computer-implemented method when executed on data processing hardware causes the data processing hardware to perform operations comprising:
receiving, as input to an agile adaptive control model, planning data of a vehicle;
receiving, as input to the agile adaptive control model, vehicle data of the vehicle;
initiating an agile learn model of the adaptive control model to update initial adaptive design parameters based on the planning data and the vehicle data;
generating updated adaptive design parameters; and
generating, using a control model of the adaptive control model, a control command based on the updated adaptive design parameters.

19. The method of claim 18, wherein generating the updated adaptive design parameters comprises:
calculating a first gain of the initial adaptive design parameters and a second gain of the initial adaptive design parameters; and
applying an adaptive filter to the initial adaptive design parameters.

20. The method of claim 19, wherein the adaptive filter applies one or more preset vehicle parameters to the first gain of the initial adaptive design parameters and the second gain of the initial adaptive design parameters.
